(19) United States
(12) Patent Application Publication
(10) Pub. No.: US 2008/0240522 A1
(43) Pub. Date: Oct. 2, 2008

(54) Fingerprint Authentication Method Involving Movement of Control Points

(76) Inventor: Srinivas Venkata Rama Gutta, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/598,891

(22) PCT Filed: Mar. 14, 2005
(86) PCT No.: PCT/IB05/50896

§ 371 Date: Sep. 14, 2006

Related U.S. Application Data
(60) Provisional application No. 60/553,748, filed on Mar. 16, 2004.

(51) Int. Cl. G06K 9/00

(52) U.S. Cl. 382/125

(57) ABSTRACT

A fingerprint system (80) implements a fingerprint authentication method (20) for a user fingerprint image (UFI) based on a plurality of control fingerprint images (CFI). The method involves (S24) a detection of at least one control point within a user fingerprint image (UFI) and at least one control point within each control fingerprint image (CFI), (S26) a superimposing of the user fingerprint image (UFI) with each control fingerprint image (CFI) as a function of a movement of one or more control points within at least one the user fingerprint image and one or more control fingerprint images, and (S28) an authentication of the control fingerprint image (CFI) having the shortest superimposition distance with the user fingerprint image (UFI) as an identified fingerprint image (IFI).

The present invention generally relates to fingerprinting authentication methods and systems. The present invention specifically relates to fingerprinting authentication systems implementing a method involving the movement of control points within a control fingerprint image and a user fingerprint image.

Fingerprint systems as known in the art employ fingerprint enrollment modules for enrolling enrollees and their fingerprints into a system database, and fingerprint authentication modules for authenticating an identity of a particular user of the system from a fingerprint stored on the system database. These fingerprint systems work well when a user places his or her finger on a fingerprint sensor during an authentication of the user in the same way the user placed his or her finger on the fingerprint sensor during an enrollment of the user. Conversely, a performance of the fingerprint system is drastically reduced if the user does not place his or her finger on the fingerprint sensor during an authentication of the user in the same way the user placed his or her finger on the fingerprint sensor during an enrollment of the user. This is particularly true for pressure sensors that measure pressures to differentiate ridge and valleys of a fingerprint, such as, for example, the pressure sensor disclosed in U.S. Pat. No. 6,578,436 B1 entitled “Method and Apparatus for Pressure Sensing” and issued Jun. 17, 2003, which is hereby incorporated by reference herein in its entirety.

The present invention provides a new and unique distance metric based fingerprint authentication method premised on the movement of control points within a control fingerprint image and a user fingerprint image.

One form of the present invention is a fingerprint authentication method involving a detection of at least one control point within a user fingerprint image and within at least two control fingerprint images, a superimposition of the user fingerprint image with each control fingerprint image as a function of a movement of one or more control points within the user fingerprint image and/or one or more control fingerprint images, and an authentication of the control fingerprint image having the shortest superimposition distance as an identified fingerprint image.

A second form of the present invention is a fingerprint authentication system employing means for detecting of at least one control point within a user fingerprint image and within at least two control fingerprint images, means for superimposing the user fingerprint image with each control fingerprint image as a function of a movement of one or more control points within the user fingerprint image and/or one or more control fingerprint images, and means for authenticating the control fingerprint image having the shortest superimposition distance as an identified fingerprint image.

A third form of the present invention is a fingerprint identification system employing a database for storing a plurality of control fingerprint images. The system further employs a fingerprint authentication module operable to retrieve the control fingerprint images from the database to thereby authenticate one of the control fingerprint images with a user fingerprint image. The fingerprint authentication module is further operable to detect at least one control point within a user fingerprint image and within at least two control fingerprint, to superimpose the user fingerprint image with each control fingerprint image as a function of a movement of one or more control points within the user fingerprint image and/or one or more control fingerprint images, and to authenticate the control fingerprint image having the shortest superimposition distance as an identified fingerprint image.

The term “module” is defined herein as a structural configuration of hardware and/or software.

The foregoing forms as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

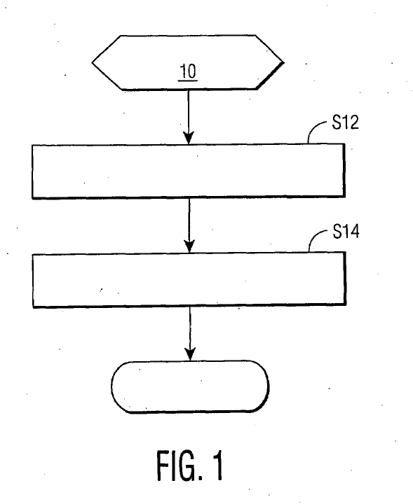

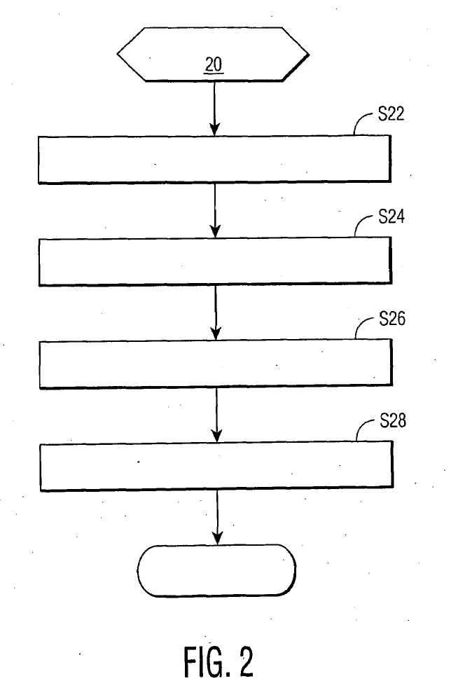

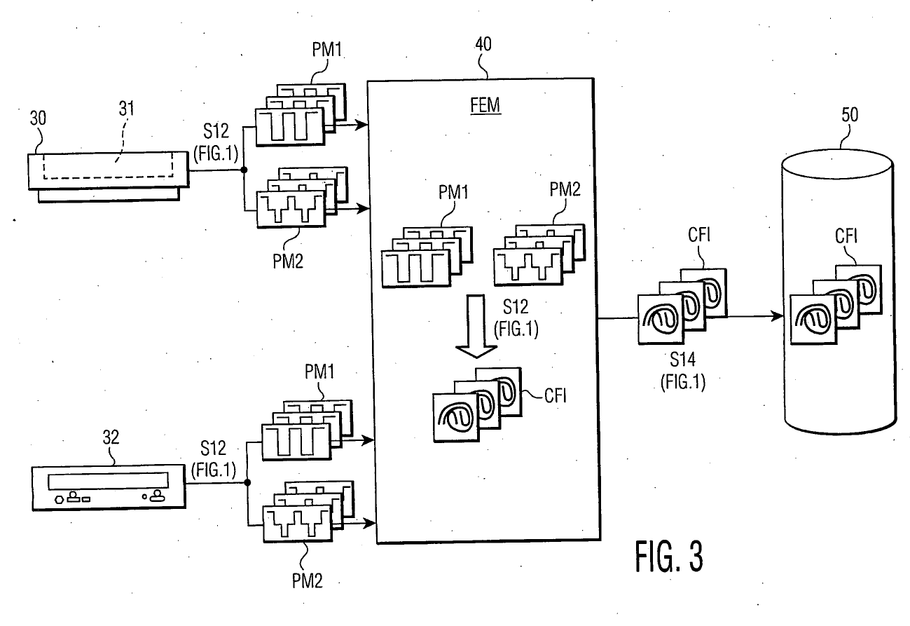

FIG. 1 illustrates a flowchart representative of one embodiment of a fingerprint enrollment method in accordance with the present invention;

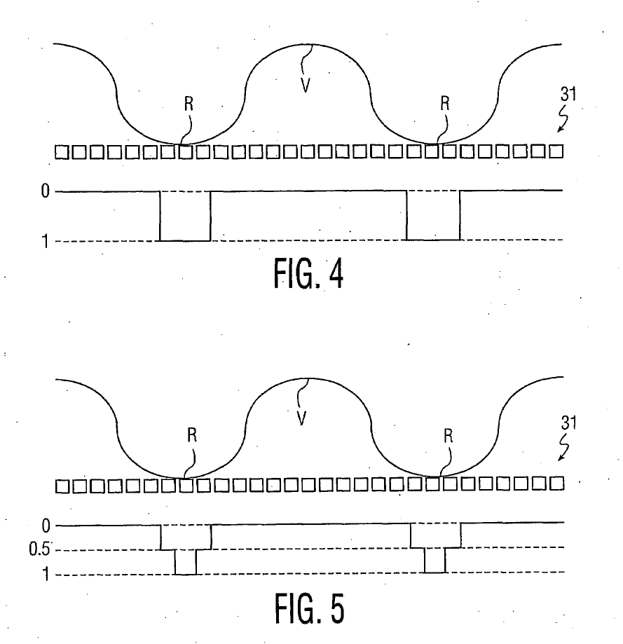

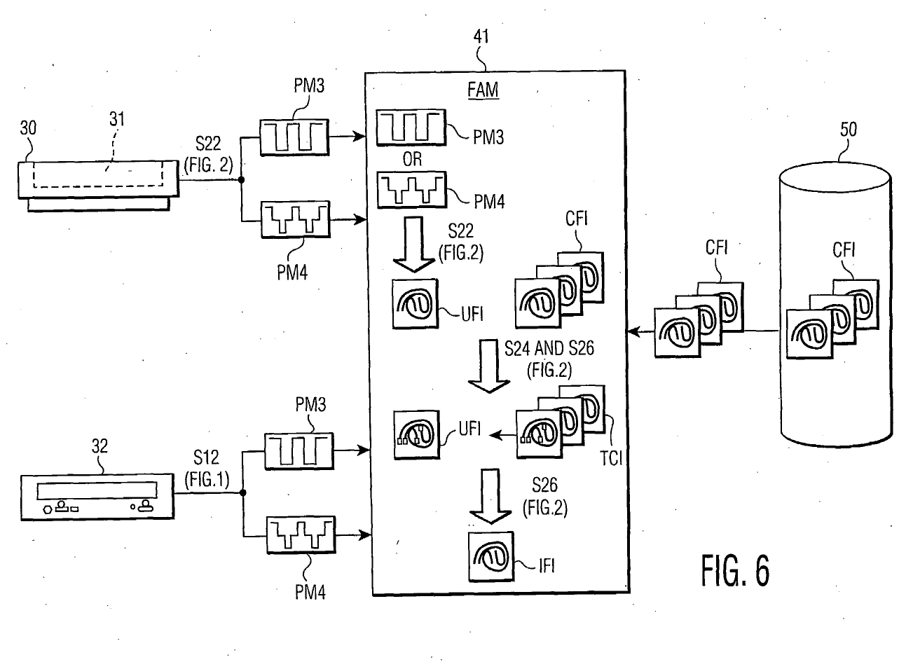

FIG. 2 illustrates a flowchart representative of one embodiment of a fingerprint authentication method in accordance with the present invention;

FIG. 3 illustrates one embodiment of a fingerprint enrollment system in accordance with the present invention for implementing the fingerprint enrollment method illustrated in FIG. 1;

FIG. 4 illustrates a first exemplary pulse response from a first embodiment of a pressure sensor in accordance with the present invention;

FIG. 5 illustrates a second exemplary pulse response from a second embodiment of a pressure sensor in accordance with the present invention;

FIG. 6 illustrates one embodiment of a fingerprint authentication system in accordance with the present invention for implementing the fingerprint authentication method illustrated in FIG. 2;

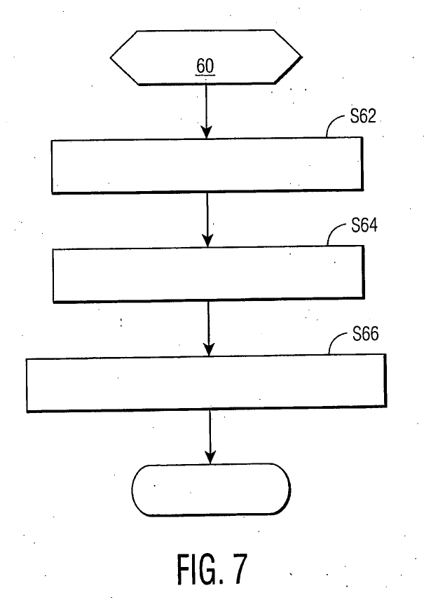

FIG. 7 illustrates a flowchart representative of one embodiment of a fingerprint superimposition method in accordance with the present invention;

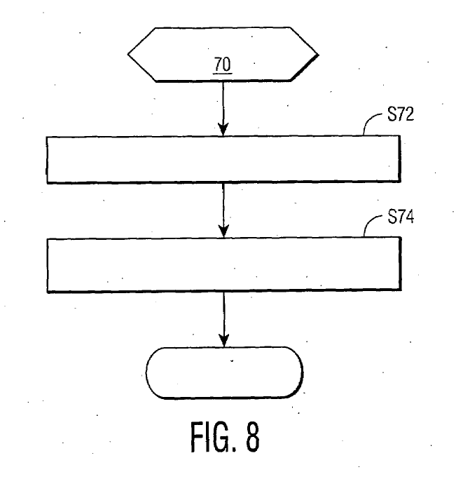

FIG. 8 illustrates a flowchart representative of one embodiment of a fingerprint selection method in accordance with the present invention; and

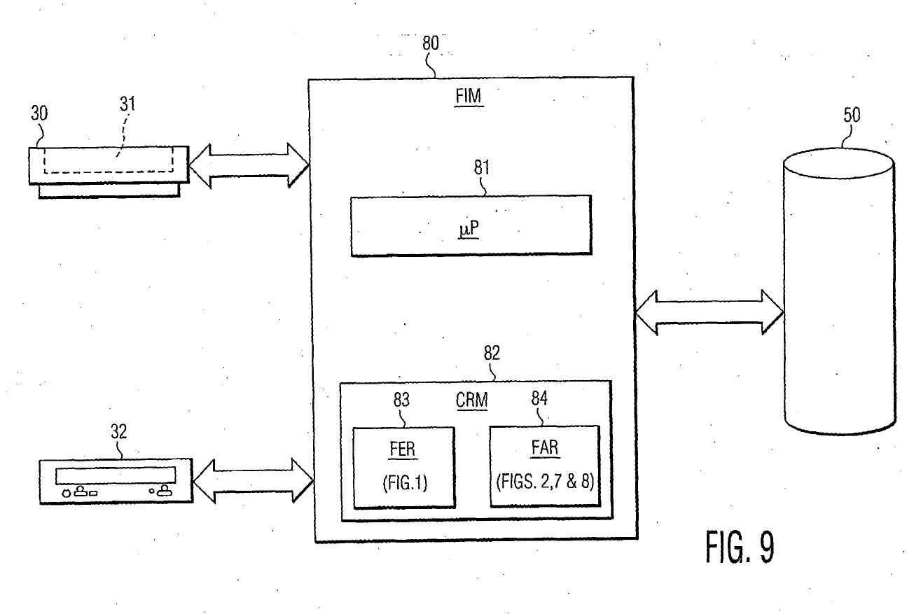

FIG. 9 illustrates one embodiment of a fingerprint identification system in accordance with the present invention for implementing the fingerprint enrollment method and the fingerprint authentication method illustrated in FIGS. 1 and 2, respectively.

A flowchart 10 illustrated in FIG. 1 is representative of a fingerprint enrollment method of the present invention. During a stage S12 of flowchart 10, a control fingerprint image for an enrollee is acquired. In practice, the type of technique employed for acquiring the control fingerprint image of the enrollee is dependent upon a commercial implementation of the present invention, and is therefore without limit.

In one exemplary embodiment, a conventional pressure sensor 30 having a sensory array 31 (e.g., a pressure sensor disclosed in U.S. Pat. No. 6,578,436 B1) is employed to acquire a conventional pressure map PM1 of the enrollee as exemplary illustrated in FIG. 3 that is based on conventional pulse responses as exemplary illustrated in FIG. 4 for differentiating between ridges R via a digital “1” and valleys V via a digital “0”. A fingerprint enrollment module (“FEM”) 40 as illustrated in FIG. 3 is thereafter employed to conventionally derive a control fingerprint image CFI from pressure map PM1 of the enrollee.

In a second exemplary embodiment, pressure sensor 30 is employed to acquire a pressure map PM2 of the enrollee as illustrated in FIG. 3 that is based on pulse responses as exemplary illustrated in FIG. 4 for differentiating between peaks of ridges R via a digital “1”, non-peaks of ridges R via a digital “0.5”, and valleys V via a digital “0”. Those having ordinary skill in the art will appreciate a structural modification of the pressure sensor disclosed in U.S. Pat. No. 6,578,436 B1 that would enable an acquisition of pressure map PM2 and the like. Fingerprint enrollment module 40 is thereafter employed to conventionally derive a control fingerprint image CFI from pressure map PM2 of the enrollee.

In a third exemplary embodiment, a digital input device of any type is employed to acquire a pre-generated pressure map PM1 or a pre-generated pressure map PM2, such as, for example, a disk drive 32 as illustrated in FIG. 3, a card reader and a scanner. Fingerprint enrollment module 40 is thereafter employed to conventionally derive a control fingerprint image CFI from the pre-generated pressure map PM1 or the pre-generated pressure map PM2 of the enrollee.

During a stage S14 of flowchart 10, the control fingerprint image is stored. In practice, the type of technique employed for storing the control fingerprint image is dependent upon a commercial implementation of the present invention, and is therefore without limit. In one exemplary embodiment, fingerprint enrollment module 40 manages a storing of a file for control fingerprint image CFI into a database 50 as exemplary illustrated in FIG. 3 where the file includes a name of the enrollee, one or more conventional templates constituting control fingerprint image CFI, and any other information necessary for future authentications involving the control fingerprint image CFI.

Flowchart 10 is terminated upon completion of stage S14, and is re-implemented upon a new enrollment. For purposes of facilitating an understanding of the fingerprint authentication method of the present invention, the subsequent description herein of FIGS. 2, and 6-8 are based on the acquisition of the three (3) pressure maps of any type from three (3) enrollees and the storage of three (3) control fingerprint images for the three (3) enrollees. However, those having ordinary skill in the art will appreciate the applicability of the present invention to any number of enrollees. Additionally, those having ordinary skill in the art will appreciate that the maximum number of enrollees is dependent upon the size of the database or databases for storing the control fingerprint images of all enrollees.

A flowchart 20 illustrated in FIG. 2 is representative of a fingerprint authentication method of the present invention. During a stage S22 of flowchart 20, a user fingerprint image is acquired. In practice, the type of technique employed for acquiring the user fingerprint image is dependent upon a commercial implementation of the present invention, and is therefore without limit.

In one exemplary embodiment, pressure sensor 30 or a digital input device 32 are employed to acquire a pressure map PM3 or a pressure map PM4, and a fingerprint authentication module (“FAM”) 41 as illustrated in FIG. 6 is employed to conventionally derive a user fingerprint image UFI as illustrated in FIG. 6 from pressure map PM3 or pressure map PM4. User fingerprint image UFI constitutes a black and white fingerprint image when derived from pressure map PM3. User fingerprint image UFI constitutes a grayscale fingerprint image when derived from pressure map PM4.

During a stage S24 of flowchart 20, control points (e.g., cores, deltas, ridge endings, ridge bifurcations, etc.) within the user fingerprint image and the control fingerprint images are conventionally detected. In practice, the type of technique employed for computing control points within the images is dependent upon a commercial implementation of the present invention, and is therefore without limit.

In one exemplary embodiment, a fingerprint authentication module 41 as illustrated in FIG. 6 is employed to detect control points within user fingerprint image UFI and within each control fingerprint image CFI as exemplary illustrated in FIG. 6. These control point computations by fingerprint authentication module 41 are accomplished in accordance with a publication by Anil K. Jain and Sharath Pankanti entitled “Fingerprint Matching and Classifications”, in Handbook of Image Processing, A. Bovik (ed.), pp. 821-835, Academic Press, 2000, which is hereby incorporated by reference in its entirety.

During a stage S26 of flowchart 20, the detected control points of the user fingerprint image and/or the control fingerprint images are conventionally moved within the images to superimpose the user fingerprint image with each control fingerprint image. In practice, the type of technique employed for moving the control points within the images is dependent upon a commercial implementation of the present invention, and is therefore without limit. In one exemplary embodiment, fingerprint authentication module 41 implements a flowchart 60 as illustrated in FIG. 7 that is representative of a fingerprint superimposition method.

During a stage S62 of flowchart 60, the user fingerprint image and a control fingerprint image are conventionally registered into a common frame of reference involving an alignment based on rotation, translation, and/or scaling. In practice, the type of technique employed for registering the images is dependent upon a commercial implementation of the present invention, and is therefore without limit. In one exemplary embodiment, fingerprint authentication module 41 as illustrated in FIG. 6 is employed to register the user fingerprint image UFI and a control fingerprint image CFI in accordance with a publication by Anil K. Jain, L. Hong, Sharath Pankanti and R. Bolle entitled “On-Line Identity-Authentication System Using Fingerprints”, Proceedings of IEEE (Special Issue of Biometrics), vol. 85, pp. 1365-1388, September 1997, which is hereby incorporated by reference in its entirety.

During a stage S64 of flowchart 60, the detected control points are moved within the user fingerprint image and/or the control fingerprint image to superimpose the ridges of the user fingerprint image onto the ridges of the control fingerprint image, or vice-versa. In practice, the type of technique employed for moving the control points within the images to superimpose the ridges of the user fingerprint image unto the ridges of the control fingerprint image or vice-versa is dependent upon a commercial implementation of the present invention, and is therefore without limit.

In one exemplary embodiment, fingerprint authentication module 41 as illustrated in FIG. 6 moves the control points within user fingerprint image UFI and/or a control fingerprint image CFI within pre-defined tolerance parameters and/or filtering parameters designed to facilitate a reasonable superimposition of the ridges of user fingerprint image UFI with the ridges of the control fingerprint image CFI, or vice-versa. Any pre-defined tolerance parameters and filtering parameters are design driven based on the commercial implementation of the present invention, and are therefore without limit.

During a stage S66 of flowchart 60, a superimposition distance is computed. In practice, the type of technique employed for computing the superimposition distance is dependent upon a commercial implementation of the present invention, and is therefore without limit. In one exemplary embodiment, fingerprint authentication module 41 as illustrated in FIG. 6 is employed to compute the superimposition distance by counting of the number of control point movements within the user fingerprint image UFI and/or the control fingerprint image CFI required to superimpose the ridges of the user fingerprint image FUI unto the ridges of the control fingerprint image CFI, or vice-versa.

Flowchart 60 terminates after stage S66, and is repeated for each control fingerprint image to in accordance with flowchart 60. A stage S28 of flowchart 20 is implemented upon obtaining all of the necessary superimposed control fingerprint images (e.g., three (3) transformed control fingerprint images as illustrated in FIG. 6).

Referring again to FIG. 2, the control fingerprint image having the shortest superimposition distance is authenticated as the control fingerprint image during stage S28. In practice, the type of technique employed for determining the control fingerprint image having the shortest superimpositions distance is dependent upon a commercial implementation of the present invention, and is therefore without limit. In one exemplary embodiment, fingerprint authentication module 41 implements a flowchart 70 as illustrated in FIG. 8 that is representative of a fingerprint selection method.

During a stage S72 of flowchart 70, the superimposition distances are conventionally sorted by number of control point movement steps. In practice, the type of technique employed for sorting superimpositions distance by number of control point movement steps is dependent upon a commercial implementation of the present invention, and is therefore without limit. Such sorting can be accomplished within a static or dynamic filter, which is without limit.

During a stage S74 of flowchart 70, the superimposition distance having the fewest control point movement steps is selected as the shortest one from the sorted group. Flowchart 70 is terminated upon completion of stage S74.

Referring again to FIG. 2, flowchart 20 is terminated upon completion of stage S28, and is re-implemented upon a need to authenticate a new user.

While the implementations of flowchart 10 (FIG. 1), flowchart 20 (FIG. 2), flowchart 60 (FIG. 7) and flowchart 70 (FIG. 8) were described herein in a sequential execution of stages, the implementation order of the stages in practice is without limit.

Those of ordinary skill in the art will appreciate that, in practice, a structural implementation of module 40 (FIG. 3) and module 41 (FIG. 6) will vary depending on the specific implementation of a system or system embodying the present invention. Thus, the variety of actual hardware platforms and software environments for structurally implementing modules 40 and 41 is without limit.

In one exemplary embodiment, a fingerprint identification module (“FIM”) 80 of the present invention as illustrated in FIG. 9 employs a conventional processor (“μP”) 81 of any type (e.g., a digital signal processor encompassing the processing hardware, in part or in whole, of modules 40 and 41. Fingerprint identification module 80 also employs a conventional computer readable medium 82 of any type (e.g., a hard drive, etc.) for storing computer instructions programmed, conventional or otherwise, in a fingerprint enrollment routine (“FER”) 83 encompassing flowchart 10 (FIG. 1), and for storing computer instructions for storing computer instructions programmed, conventional or otherwise, in a fingerprint authentication routine (“FAR”) 84 encompassing flowchart 20 (FIG. 2), flowchart 60 (FIG. 7) and flowchart 70 (FIG. 8). As such, processor 81 can be operated to execute a conventional operating system to control program execution of the computer instructions of routines 83 and 84, and to interface with pressure sensor 30, disk driver 32 and database 50 on a local or network basis.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A fingerprint authentication method (20) for a user fingerprint image (UFI) based on a plurality of control fingerprint images (CFI), comprising:
(S24) detecting at least one control point within the user fingerprint image (UFI) and at least one control point within each control fingerprint image (CFI);
(S26) superimposing the user fingerprint image (UFI) with each control fingerprint image (CFI) as a function of a movement of one or more control points within at least one of the user fingerprint image (UFI) and one or more of the control fingerprint images (CFI); and
(S28) authenticating a first control fingerprint image (CFI) having a shortest superimposition distance as an identified fingerprint image (IFI).

2. The fingerprint authentication method (20) of claim 1, further comprising:
(S22) deriving the user fingerprint image (UFI) from a pressure map (PM), wherein the user fingerprint image (UFI) is a black and white fingerprint image.

3. The fingerprint authentication method (20) of claim 1, further comprising:
(S22) deriving the user fingerprint image (UFI) from a pressure map (PM), wherein the user fingerprint image (UFI) is a grayscale fingerprint image.

4. The fingerprint authentication method (20) of claim 1, superimposing the user fingerprint image (UFI) with each control fingerprint image (CFI) as a function of a movement of the control points includes:
(S64) moving the detected control points within at least one of the user fingerprint image (UFI) and a first control fingerprint image (CFI) to superimpose a first set of ridges of the user fingerprint image (UFI) and a second set of ridges of the first control fingerprint image (CFI)

5. The fingerprint authentication method (20) of claim 4, wherein (S28) authenticating of the control fingerprint image (CFI) having the shortest superimposition distance with the user fingerprint image (UFI) as an identified fingerprint image (IFI) includes:
(S72) sorting a group of superimposition distances based on a number of control point movement steps; and
(S74) selecting a superimposition distance having the fewest control point movement steps as the shortest superimposition distance.

6. A fingerprint identification system (80) for a user fingerprint image (UFI) based on a plurality of control fingerprint images (CFI), comprising:
(S24) means for detecting at least one control point within the user fingerprint image (UFI) and at least one control point within each control fingerprint image (CFI);
(S26) means for superimposing the user fingerprint image (UFI) with each control fingerprint image (CFI) as a function of a movement of one or more control points within at least one of the user fingerprint image (UFI) and one or more of the control fingerprint images (CFI); and
(S28) means for authenticating a first control fingerprint image (CFI) having a shortest superimposition distance as an identified fingerprint image (IFI).

7. The fingerprint identification system (80) of claim 6, further comprising:
(S22) means for deriving the user fingerprint image (UFI) from the pressure map (PM), wherein the user fingerprint image (UFI) is a black and white fingerprint image.

8. The fingerprint identification system (80) of claim 6, further comprising:
(S22) means for deriving the user fingerprint image (UFI) from the pressure map (PM), wherein the user fingerprint image (UFI) is a grayscale fingerprint image.

9. A fingerprint identification system, comprising:
a database (50) operable to store a plurality of control fingerprint images (CFI); and
a fingerprint authentication module (41) operable to retrieve at least two control fingerprint images (CFI) from the database (50) to thereby authenticate one of the control fingerprint images (CFI) with a user fingerprint image (UFI),
wherein the fingerprint authentication module (41) is further operable to detect at least one control point within a user fingerprint image (UFI) and at least one control point within each control fingerprint images (CFI);
wherein the fingerprint authentication module (41) is further operable to superimpose the user fingerprint image (UFI) with each control fingerprint image (CFI) as a function of a movement of one or more control points within the at least one of the user fingerprint image (UFI) and one or more of the control fingerprint images (CFI); and
wherein the fingerprint authentication module (41) is further operable to authenticate the control fingerprint image (CFI) having the shortest superimposition distance as an identified fingerprint image (IFI).

10. The fingerprint identification system of claim 9, wherein the fingerprint authentication module (41) is further operable to derive the user fingerprint image (UFI) from a pressure map (PM), the user fingerprint image (UFI) being a black and white fingerprint image.

11. The fingerprint identification system of claim 9, wherein the fingerprint authentication module (41) is further operable to derive the user fingerprint image (UFI) from a pressure map (PM), the user fingerprint image (UFI) being a grayscale fingerprint image.

12. The fingerprint identification system of claim 9, wherein, during a superimposing of the user fingerprint image (UFI) with each control fingerprint image (CFI) as a function of a movement of one or more control points within the at least one of the user fingerprint image (UFI) and one or more of the control fingerprint images (CFI), the fingerprint authentication module (41) is further operable to move one or more control points within at least one of the user fingerprint image (UFI) and a first control fingerprint image (CFI) to superimpose a first set of ridges of the user fingerprint image (UFI) and a second set of ridges of the first control fingerprint image (CFI).

13. The fingerprint identification system of claim 9, wherein, during an authentication of the control fingerprint image (CFI) having the shortest superimposition distance as the identified fingerprint image (IFI), the fingerprint authentication module (41) is further operable to sort a group of superimposition distances based on a number of control point movement steps, and to select a superimposition distance having the fewest control point movement steps as the shortest superimposition distance.
